(19) United States
(12) Patent Application Publication
(10) Pub. No.: US 2018/0330458 A1
(43) Pub. Date: Nov. 15, 2018

(54) Frameworks and Methodologies Configured to Enable Management of Lost Property, for Example in School

(71) Applicant: School Apparel Solutions Pty Ltd, Ultimo (AU)

(72) Inventor: Eugene Holdenson Kimura, Sydney (AU)

(73) Assignee: School Apparel Solutions Pty Ltd, Ultimo (AU)

(21) Appl. No.: 15/755,798

(22) PCT Filed: Aug. 25, 2016
(86) PCT No.: PCT/AU2016/050786

§ 371 Date: Feb. 27, 2018

(30) Foreign Application Priority Data
Aug. 27, 2015 (AU) 2015903468

(51) Int. Cl. G06Q 50/26; G06K 19/07; G06F 17/30; G06F 21/62

(52) U.S. Cl. CPC G06Q 50/26; G06F 21/6218; G06F 17/30943; G06K 19/0723

(57) ABSTRACT

Described herein are systems and methods for assisting in management of lost property items. It should be appreciated that the technology, or aspects thereof, is also applicable in alternate implementation environments (for example in the context of monitoring returns in respect of gear rentals). Various embodiments relate to technology operable in frameworks whereby a process for associating user contact information with one or more RFID tags is facilitated in a streamlined manner, thereby to provide a convenient item/tag registration method.

### RELATED APPLICATIONS

This application claims benefit of PCT/AU2016/050786 filed Aug. 25, 2016, which claims benefit of Australian Patent Application No. 2015903468, filed Aug. 27, 2015, both of which are incorporated by reference in their entirety.

### FIELD OF THE INVENTION

The present invention relates to frameworks and methodologies configured to enable automated delivery of notifications based on readable tokens. Embodiments of the invention have been particularly developed for enabling enable management of lost property, for example in schools. While some embodiments will be described herein with particular reference to that application, it will be appreciated that the invention is not limited to such a field of use, and is applicable in broader contexts.

### BACKGROUND

Any discussion of the background art throughout the specification should in no way be considered as an admission that such art is widely known or forms part of common general knowledge in the field.

School children are notorious for losing items, such as school uniform garments. Conventionally, the garments are placed in a “lost and found”, of which there may be several for a given school. Often, garments are never collected.

### SUMMARY

The embodiments described herein overcome or ameliorate at least one of the disadvantages of the prior art, or to provide a useful alternative.

One embodiment provides a method for operating a computer system thereby to manage a lost property facility, the method including:

maintaining access to a database that is configured to store a plurality of user records, wherein each user record contains: (i) data representative of a RFID token UID for a unique RFID token, wherein the RFID token UID is unique relative to a first collection of identifiers; and (ii) data representative of a user contact;

receiving data representative of a visually readable identifier, and a specific user contact, wherein the visually readable identifier is unique relative to a second collection of identifiers, wherein the number of possible unique identifiers in the second collection is less than the number of possible unique identifiers in the first collection, and wherein the visually readable identifier is not directly representative of the RFID token UID;

accessing an information repository which associates each RFID token UID to one of the visually readable identifiers, and thereby identifying RFID token UID associated with the visually readable identifier based on accessing an information repository that associates each RFID token UID with a unique visually readable identifier;

causing updating of the database to store a record containing: (i) data representative of the identified RFID token UID; (ii) data representative of the specific visually readable identifier; and (iii) data representative of the specific user contact;

receiving a signal from a lost property device, wherein the lost property device includes a reader device that is configured to read a RFID token carried by an item that is placed in a location associated with the lost property device, wherein the signal is representative of a read RFID token UID;

querying the database thereby to identify a record containing the read RFID token UID, and determine the user contact for that record; and

causing transmittal of an electronic notification to the determined user contact.

One embodiment provides a method wherein: the data representative of a specific visually readable identifier and a specific user contact is received by way of an electronic communication sent via the specific user contact; and wherein the received data is representative of the user contact as a result of originating from that contact.

One embodiment provides a method wherein the message includes one or more of: (i) a SMS; (ii) and email; and (iii) another form of electronic communication.

One embodiment provides a method wherein the item is a wearable garment in which the token is embedded.

One embodiment provides a method for managing a lost property facility, the method including:

providing a plurality of garments, wherein each garment carries: (i) a RFID token having a token UID, wherein the RFID token UID is unique relative to a first collection of identifiers; and (ii) a visually readable identifier, wherein the visually readable identifier is unique relative to a second collection of identifiers, wherein the number of possible unique identifiers in the second collection is less than the number of possible unique identifiers in the first collection, and wherein the visually readable identifier is not directly representative of the RFID token UID wherein an information repository associates, for each garment, the RFID token with the visually readable identifier;

providing a plurality of lost property devices, wherein each lost property device includes a reader device that is configured to: (i) read a RFID token carried by an item that is placed in a storage location associated with the lost property device, thereby to determine the token UID; and (ii) in response to reading a given RFID token, communicate a signal to a server device, wherein the signal is representative of a read RFID token UID;

providing a portal that is configured to receive electronic messages from user devices, wherein each electronic message is: (i) received from a specific user contact; and (ii) includes data representative of the visually readable identifier for a given garment;

performing an automated process, in response to a given electronic message received via the portal, thereby to cause a database to store a record that contains: (i) data representative of the RFID token associated with the visually readable identifier of which the electronic message is representative; and (ii) the contact from which the electronic message is received; and

configuring the server device to process a signal received from a given one of the lost property device, wherein the processing includes: (i) querying the database; (ii) identifying the contact for a record that contains the RFID token UID of which the signal is representative; and (iii) communicating an electronic message to the contact.

One embodiment provides a method for managing lost property including:

embedding RFID tags in garments;

maintaining a database that associates each RFID tag with a user contact; and

providing an electronic message to a given contact when the associated RFID dag is read at by a lost property device.

One embodiment provides a method for operating a computer system thereby to manage a lost property facility, the method including:

maintaining access to a database that is configured to store a plurality of user records, wherein each user record contains: (i) data representative of a RFID token UID for a unique RFID token, wherein the RFID token UID is unique relative to a first collection of identifiers; and (ii) data representative of a user contact;

receiving, in respect of a sales transaction for an item carrying one of the unique RFID tokens, data representative of the unique RFID token, and data representative of an associated visually readable identifier wherein the visually readable identifier is unique relative to a second collection of identifiers, wherein the number of possible unique identifiers in the second collection is less than the number of possible unique identifiers in the first collection, and wherein the visually readable identifier is not directly representative of the RFID token UID, and a specific user contact, wherein the data is provided by a computer system configured to perform a sales transaction in respect the item and receive input representative of the specific user contact in the context of that transaction;

causing updating of the database to store a record containing: (i) data representative of the identified RFID token UID; and (ii) data representative of the specific user contact;

receiving a signal from a lost property device, wherein the lost property device includes a reader device that is configured to read a RFID token carried by an item that is placed in a location associated with the lost property device, wherein the signal is representative of a read RFID token UID;

querying the database thereby to identify a record containing the read RFID token UID, and determine the user contact for that record; and

causing transmittal of an electronic notification to the determined user contact.

One embodiment provides a method wherein the lost property device is configured such that the reader device is configured to read a wirelessly readable token carried by an item that is placed in a receptacle but not a wirelessly readable token carried by an item that passes proximal the receptacle.

One embodiment provides a method wherein the lost property device includes shielding configured to prevent reading of a wirelessly readable token carried by an item that passes proximal the receptacle.

One embodiment provides a method wherein the lost property device is configured such that the reader device performs a scanning procedure to read proximal tokens on a predefined schedule.

One embodiment provides a method for operating a computer system thereby to manage a lost property facility, the method including:

maintaining access to a database that is configured to store a plurality of user records, wherein each user record contains: (i) data representative of a wirelessly readable token UID for a unique wirelessly readable token; and (ii) data representative of a user contact;

receiving, in respect of a sales transaction for an item carrying one of the unique wirelessly readable tokens, data representative of the unique wirelessly readable token, or an associated visually readable identifier, and a specific user contact, wherein the data is provided by a computer system configured to perform a sales transaction in respect the item and receive input representative of the specific user contact in the context of that transaction;

causing updating of the database to store a record containing: (i) data representative of the identified wirelessly readable token UID; and (ii) data representative of the specific user contact;

receiving a signal from a lost property device, wherein the lost property device includes a reader device that is configured to read a wirelessly readable token carried by an item that is placed in a location associated with the lost property device, wherein the signal is representative of a read wirelessly readable token UID;

querying the database thereby to identify a record containing the read wirelessly readable token UID, and determine the user contact for that record; and

causing transmittal of an electronic notification to the determined user contact.

One embodiment provides a computer program product for performing a method as described herein.

One embodiment provides a non-transitory carrier medium for carrying computer executable code that, when executed on a processor, causes the processor to perform a method as described herein.

One embodiment provides a system configured for performing a method as described herein.

Reference throughout this specification to “one embodiment”, “some embodiments” or “an embodiment” means that a particular feature, structure or characteristic described in connection with the embodiment is included in at least one embodiment. Thus, appearances of the phrases “in one embodiment”, “in some embodiments” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

In the claims below and the description herein, any one of the terms comprising, comprised of or which comprises is an open term that means including at least the elements/features that follow, but not excluding others. Thus, the term comprising, when used in the claims, should not be interpreted as being limitative to the means or elements or steps listed thereafter. For example, the scope of the expression a device comprising A and B should not be limited to devices consisting only of elements A and B. Any one of the terms including or which includes or that includes as used herein is also an open term that also means including at least the elements/features that follow the term, but not excluding others. Thus, including is synonymous with and means comprising.

As used herein, the term “exemplary” is used in the sense of providing examples, as opposed to indicating quality. That is, an “exemplary embodiment” is an embodiment provided as an example, as opposed to necessarily being an embodiment of exemplary quality.

### BRIEF DESCRIPTION OF THE DRAWINGS

Embodiments of the invention will now be described, by way of example only, with reference to the accompanying drawings in which:

FIG. 1 schematically illustrates a framework according to one embodiment.

FIG. 2 illustrates a method according to one embodiment.

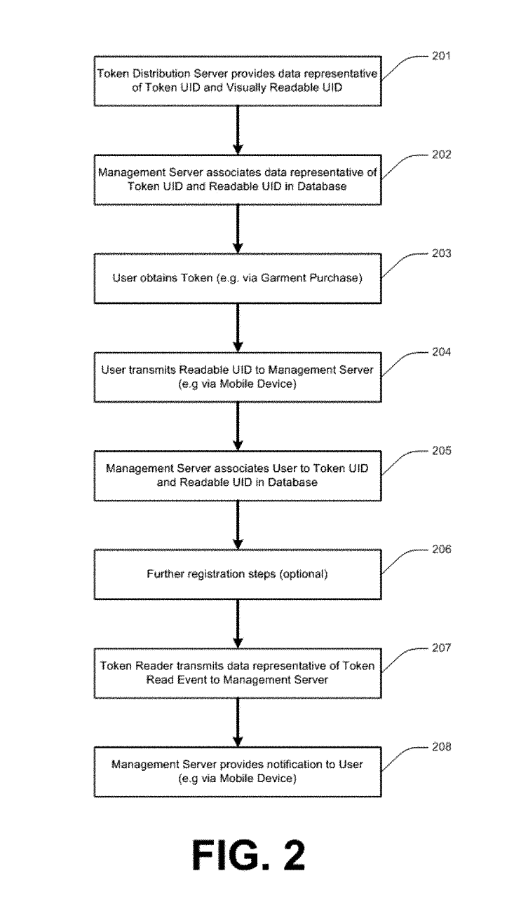

FIG. 3 illustrates a client-server framework leveraged by some embodiments.

### DETAILED DESCRIPTION

Described herein are systems and methods for assisting in management of lost property items. However, it should be appreciated that the technology, or aspects thereof, is also applicable in alternate implementation environments (for example in the context of monitoring returns in respect of gear rentals).

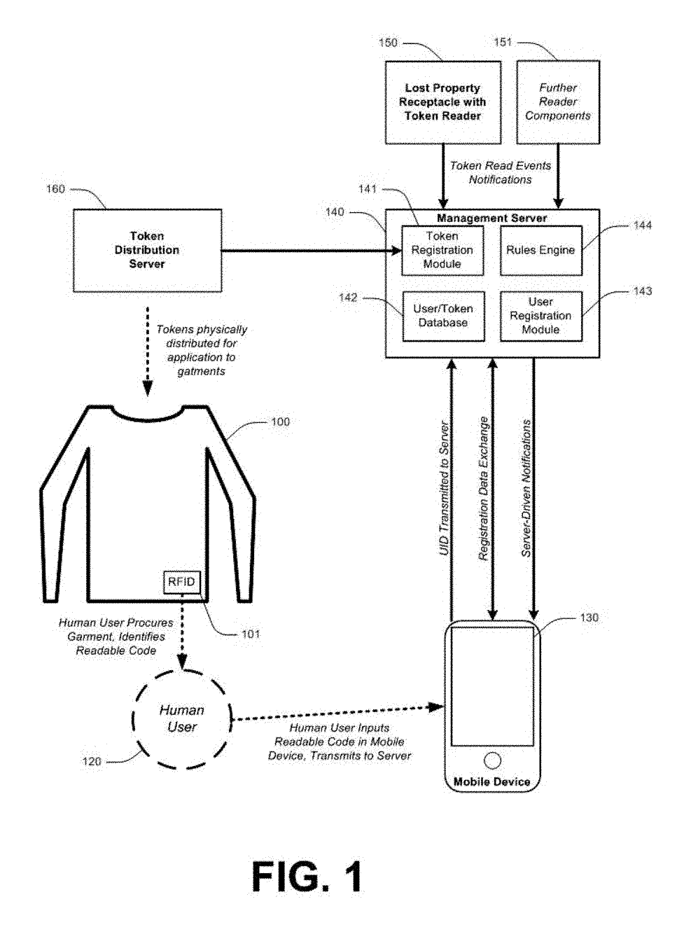

One embodiment provides a method for operating a computer system thereby to manage a lost property facility. For example, a management server 140 is illustrated in the exemplary framework of FIG. 1.

The method includes maintaining access to a database that is configured to store a plurality of user records. In FIG. 1, this is database 142. Each user record contains: (i) data representative of a wirelessly readable token UID for a unique wirelessly readable token; and (ii) data representative of a user contact.

In the present embodiment a unique wirelessly readable token is a RFID tag, and the token UID is a unique identifier that is wirelessly read from the RFID tag. For example, the RFID tag is RFID tag 101 which is embedded in a garment 100. In further embodiments the RFID tag is embedded in another item, or provided in isolation in a form configured to be mounted to and/or embedded in an item.

The user contact is, in some cases, a contact address such as a cellular telephone number, email address, user account identifier associated with a website or mobile app, or another form of contact.

As context, a user purchases an item containing a RFID tag, such as garment 100. The item also provides a visually readable identifier, which may be provided on a garment label, a portion of the garment overlying the RFID tag, on a receipt from a store that sells the garment, or elsewhere.

In preferred embodiments, the RFID token UID is unique relative to a first collection of identifiers (for example unique across all RFID tags manufactured in accordance with a particular ID system), whereas the visually readable identifier is unique relative to a second collection of identifiers (for example a collection of numerical or alphanumerical characters of predefined string length). The number of possible unique identifiers in the second collection is less than the number of possible unique identifiers in the first collection (and the visually readable identifier is not directly representative of the RFID token UID).

The visually readable identifier is different from the RFID tag wireless readable UID; preferably an alphanumeric code of under 10 characters is used. It will be appreciated that RFID tags UlDs need to be unique across a very large production cycle, whereas an identifier for a framework as herein considered may be considerably less complex (as the total number of units tokens in the framework is limited). For example, using a 5 character UID, lowercase alphanumeric only, allows for 36̂5 possible unique identifiers. In the case of a garment monitoring framework (for example in the context of school uniformed), this is potentially adequate. Furthermore, as it becomes necessary, by evolving to a 6 character UID (which involves minimal additional user input), the number of combinations increases dramatically.

In some embodiments the identifier is a graphic, such as a 2D barcode or QR code. The term “visually readable” should be read to cover any identifier that is able to be read by visual/optical means. That is, in some cases the identifier is in practice read by a human visually, and in some cases read electronically, for example by a camera device (or other device with scanning capabilities). That is, it is differentiated from an identifier that is invisible, such as an RFID tag UID.

A human user 120 obtains garment 100, and operates a client device thereby to input the visually readable identifier (for example by alphanumeric input or by image capture) communicate the visually readable identifier to server 140. In this embodiment a mobile device 130 is used, and this communicates with a user registration module 143 of server 140. Server 140 accordingly performs a step if receiving data representative of a visually readable identifier, and a specific user contact. By way of example, any of the following approaches may be used:
Sending a SMS/MMS/email (or other electronic message, such as from a proprietary app) is used to communicate the visually readable identifier to a predefined location associated with server 140. In this case, the message is inherently representative of the user's contact. That is: the data representative of a specific visually readable identifier and a specific user contact is received by way of an electronic communication sent via the specific user contact; and wherein the received data is representative of the user contact as a result of originating from that contact.
Uploading data via a web (or app) interface. This may include manual input of a contact for the user.

In some embodiments the former is performed for initial registration, and the latter performed subsequently to provide additional contact details and/or customise notifications via a registration data exchange process. The registration data exchange process in some embodiments used to assist a user in selling a second-hand item to a further user (and hence enable re-registration by the further user).

In some embodiments, registration occurs during a sales process. For example, an online shopping facility or POS terminal is configured to provide to the server a signal representative of a purchased item (in terms of the token UID or visually readable identifier) and a contact for the purchaser, such that item registration is performed automatically as part of the purchase process.

The method then includes identifying a wirelessly readable token UID associated with the visually readable identifier. This is based on accessing an information repository that associates each wirelessly readable token UID with a unique visually readable identifier. For example, in FIG. 1 a token distribution server 160 provides the relevant information to a token registration module 141 of server 140.

The method then include causing updating of database 142 to store a record containing: (i) data representative of the identified wirelessly readable token UID; (ii) data representative of the specific visually readable identifier; and (iii) data representative of the user contact.

The method additionally includes receiving a signal from a lost property device, such as lost property receptacle 150. The lost property device includes a reader device that is configured to read a wirelessly readable token carried by an item that is placed in a location associated with the lost property device (i.e. a RFID reader device in this embodiment), The signal is representative of a read wirelessly readable token UID. Other reader components 151 may also be used (for example to track garments or their wearers for alternate purposes, for example student tracking).

In response to the signal, a rules engine 144 causes querying of database 142 thereby to identify a record containing the read wirelessly readable token UID, and determine the user contact for that record, and also cause transmittal of an electronic notification to the determined user contact.

One embodiment provides a method wherein the lost property device is configured such that the reader device is configured to read a wirelessly readable token carried by an item that is placed in a receptacle but not a wirelessly readable token carried by an item that passes proximal the receptacle.

One embodiment provides a method wherein the lost property device includes shielding configured to prevent reading of a wirelessly readable token carried by an item that passes proximal the receptacle. For example, a faraday cage or the like is used.

One embodiment provides a method wherein the lost property device is configured such that the reader device performs a scanning procedure to read proximal tokens on a predefined schedule. For example, scans are performed at times when false readings are unlikely (for example, in the case of a school lost property facility, late at night or at a time when no students are likely to be present).

In some embodiments a given RFID tag is able to be re-registered to a different user. For example, a garment is sold second-hand to that different user. In the case that the different user provides a signal representative of the visually readable identifier to server 140 (as an attempt to register their contact), server 140 provides a notification to the original user, inviting to confirm that the first user approves of the re-registration.

In an alternate embodiment, as an alternative (or addition) to using a visually readable identifier, an RFID scanner is provided at a point of sale location (for example at a checkout counter or at a terminal, which may be self served or manned), thereby to enable customers to associate their contact details with the UID of the RFID chip. A signal is communicated from a computing device coupled to the RFID scanner to the sever, thereby to update the database. For example in some embodiments a registration process flow is integrated into software executed at a POS terminal, thereby to collected and submit registration data which is the associated at the server with the RFID UID.

In some embodiments, registration is streamlined via leveraging of a user account (or other source of user information, for example user information inputted in the context of an online sales transaction), which provides user information including a contact to which notifications are to be delivered (this may include a contact that is assumed to be a contact to which notifications are to be delivered). In some embodiments a user is identified via (or otherwise determined to be associated with) a user account prior to or during a sales process (either at a physical store with a POS terminal or online Internet-based store), the user account being previously associated with user contact details. Then, as part of a transaction for an item having an RFID tag, the RFID tag UID is automatically associated with the user contact details at server 140.

That is, there is no need for a post-purchase registration process for garments (or other items) purchased by a user having a predefined user account. In some embodiments a user is identified during a sales process (either at a physical or online store), the sales transaction including inputting of contact details. Then, as part of a transaction for an item having an RFID tag, the RFID tag UID is automatically associated with the user contact details at server 140. That is, again, there is no need for a post-purchase registration process for garments (or other items) purchased by a user having a predefined user account.

Although embodiments described above make reference to a garment (or other item) having an RFID tag embedded as part of a manufacturing process, the technology is equally applicable to situations making use of aftermarket RFID tag attachment. For example, an RFID tag could be applied to an item by a manufacturer during manufacture, a retailer/wholesaler prior to (or at the time of sale), or a purchase following purchase.

It should be appreciated that, whilst various embodiments above are described by reference to garments as a specific example, further embodiments include tags provide on and/or affixed to other items. These include school supplies (such as calculators, pencil cases and books), other items carried by school children (such as drink bottles, lunchboxes) and a wide range of other item types.

### Exemplary Client-Server Framework

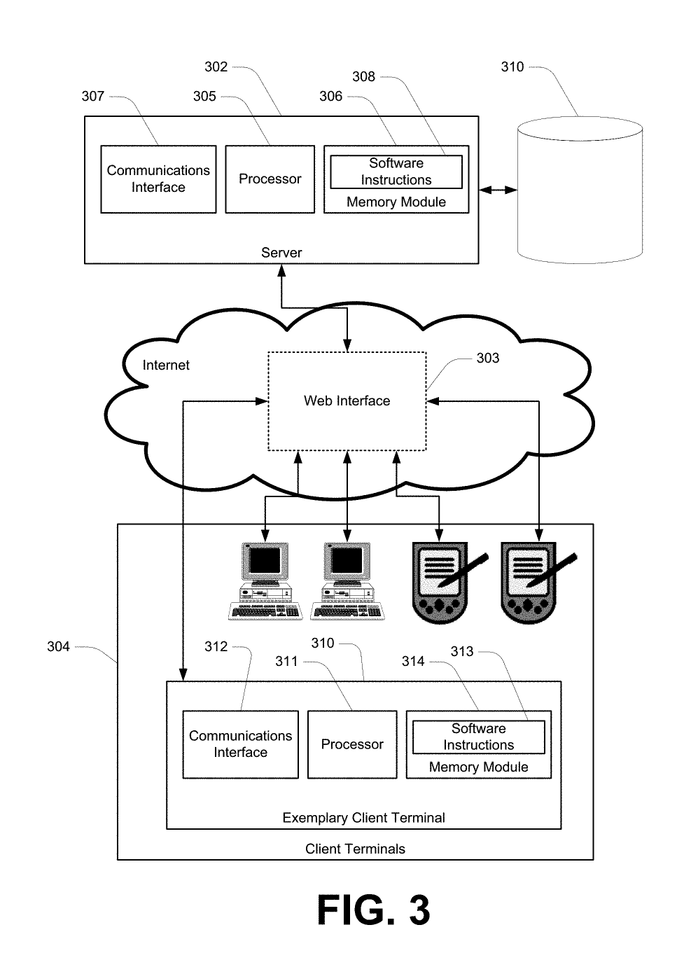

In some embodiments, methods and functionalities considered herein are implemented byway of a server, as illustrated in FIG. 3. For example, such a framework is used in the context of user registration, particularly in the context of customising contact details and notifications. It is also relevant in the context of other functionalities, such as coordinating garment second hand sales and the like.

In overview, a web server 302 provides a web interface 303. This web interface is accessed by the parties by way of client terminals 304. In overview, users access interface 303 over the Internet by way of client terminals 304, which in various embodiments include the likes of personal computers, PDAs, cellular telephones, gaming consoles, and other Internet enabled devices.

Server 303 includes a processor 305 coupled to a memory module 306 and a communications interface 307, such as an Internet connection, modem, Ethernet port, wireless network card, serial port, or the like. In other embodiments distributed resources are used. For example, in one embodiment server 302 includes a plurality of distributed servers having respective storage, processing and communications resources. Memory module 306 includes software instructions 308, which are executable on processor 305.

Server 302 is coupled to a database 310. In further embodiments the database leverages memory module 306.

In some embodiments web interface 303 includes a website. The term “website” should be read broadly to cover substantially any source of information accessible over the Internet or another communications network (such as WAN, LAN or WLAN) via a browser application running on a client terminal. In some embodiments, a website is a source of information made available by a server and accessible over the Internet by a web-browser application running on a client terminal. The web-browser application downloads code, such as HTML code, from the server. This code is executable through the web-browser on the client terminal for providing a graphical and often interactive representation of the website on the client terminal. By way of the web-browser application, a user of the client terminal is able to navigate between and throughout various web pages provided by the website, and access various functionalities that are provided.

Although some embodiments make use of a website/browser-based implementation, in other embodiments proprietary software methods are implemented as an alternative. For example, in such embodiments client terminals 304 maintain software instructions for a computer program product that essentially provides access to a portal via which framework 100 is accessed (for instance via an iPhone app or the like).

In general terms, each terminal 304 includes a processor 311 coupled to a memory module 313 and a communications interface 312, such as an internet connection, modem, Ethernet port, serial port, or the like. Memory module 313 includes software instructions 314, which are executable on processor 311. These software instructions allow terminal 304 to execute a software application, such as a proprietary application or web browser application and thereby render on-screen a user interface and allow communication with server 302. This user interface allows for the creation, viewing and administration of profiles, access to the internal communications interface, and various other functionalities.

Unless specifically stated otherwise, as apparent from the following discussions, it is appreciated that throughout the specification discussions utilizing terms such as “processing,” “computing,” “calculating,” “determining”, “analyzing” or the like, refer to the action and/or processes of a computer or computing system, or similar electronic computing device, that manipulate and/or transform data represented as physical, such as electronic, quantities into other data similarly represented as physical quantities.

In a similar manner, the term “processor” may refer to any device or portion of a device that processes electronic data, e.g., from registers and/or memory to transform that electronic data into other electronic data that, e.g., may be stored in registers and/or memory. A “computer” or a “computing machine” or a “computing platform” may include one or more processors.

The methodologies described herein are, in one embodiment, performable by one or more processors that accept computer-readable (also called machine-readable) code containing a set of instructions that when executed by one or more of the processors carry out at least one of the methods described herein. Any processor capable of executing a set of instructions (sequential or otherwise) that specify actions to be taken are included. Thus, one example is a typical processing system that includes one or more processors. Each processor may include one or more of a CPU, a graphics processing unit, and a programmable DSP unit. The processing system further may include a memory subsystem including main RAM and/or a static RAM, and/or ROM. A bus subsystem may be included for communicating between the components. The processing system further may be a distributed processing system with processors coupled by a network. If the processing system requires a display, such a display may be included, e.g., a liquid crystal display (LCD) or a cathode ray tube (CRT) display. If manual data entry is required, the processing system also includes an input device such as one or more of an alphanumeric input unit such as a keyboard, a pointing control device such as a mouse, and so forth. The term memory unit as used herein, if clear from the context and unless explicitly stated otherwise, also encompasses a storage system such as a disk drive unit. The processing system in some configurations may include a sound output device, and a network interface device. The memory subsystem thus includes a computer-readable carrier medium that carries computer-readable code (e.g., software) including a set of instructions to cause performing, when executed by one or more processors, one of more of the methods described herein. Note that when the method includes several elements, e.g., several steps, no ordering of such elements is implied, unless specifically stated. The software may reside in the hard disk, or may also reside, completely or at least partially, within the RAM and/or within the processor during execution thereof by the computer system. Thus, the memory and the processor also constitute computer-readable carrier medium carrying computer-readable code.

Furthermore, a computer-readable carrier medium may form, or be included in a computer program product.

In alternative embodiments, the one or more processors operate as a standalone device or may be connected, e.g., networked to other processor(s), in a networked deployment, the one or more processors may operate in the capacity of a server or a user machine in server-user network environment, or as a peer machine in a peer-to-peer or distributed network environment. The one or more processors may form a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine.

Note that while diagrams only show a single processor and a single memory that carries the computer-readable code, those in the art will understand that many of the components described above are included, but not explicitly shown or described in order not to obscure the inventive aspect. For example, while only a single machine is illustrated, the term “machine” shall also be taken to include any collection of machines that individually or jointly execute a set (or multiple sets) of instructions to perform any one or more of the methodologies discussed herein.

Thus, one embodiment of each of the methods described herein is in the form of a computer-readable carrier medium carrying a set of instructions, e.g., a computer program that is for execution on one or more processors, e.g., one or more processors that are part of web server arrangement. Thus, as will be appreciated by those skilled in the art, embodiments of the present invention may be embodied as a method, an apparatus such as a special purpose apparatus, an apparatus such as a data processing system, or a computer-readable carrier medium, e.g., a computer program product. The computer-readable carrier medium carries computer readable code including a set of instructions that when executed on one or more processors cause the processor or processors to implement a method. Accordingly, aspects of the present invention may take the form of a method, an entirely hardware embodiment, an entirely software embodiment or an embodiment combining software and hardware aspects. Furthermore, the present invention may take the form of carrier medium (e.g., a computer program product on a computer-readable storage medium) carrying computer-readable program code embodied in the medium.

The software may further be transmitted or received over a network via a network interface device. While the carrier medium is shown in an exemplary embodiment to be a single medium, the term “carrier medium” should be taken to include a single medium or multiple media (e.g., a centralized or distributed database, and/or associated caches and servers) that store the one or more sets of instructions. The term “carrier medium” shall also be taken to include any medium that is capable of storing, encoding or carrying a set of instructions for execution by one or more of the processors and that cause the one or more processors to perform any one or more of the methodologies of the present invention. A carrier medium may take many forms, including but not limited to, non-volatile media, volatile media, and transmission media. Non-volatile media includes, for example, optical, magnetic disks, and magneto-optical disks. Volatile media includes dynamic memory, such as main memory. Transmission media includes coaxial cables, copper wire and fiber optics, including the wires that comprise a bus subsystem. Transmission media also may also take the form of acoustic or light waves, such as those generated during radio wave and infrared data communications. For example, the term “carrier medium” shall accordingly be taken to included, but not be limited to, solid-state memories, a computer product embodied in optical and magnetic media; a medium bearing a propagated signal detectable by at least one processor of one or more processors and representing a set of instructions that, when executed, implement a method; and a transmission medium in a network bearing a propagated signal detectable by at least one processor of the one or more processors and representing the set of instructions.

It will be understood that the steps of methods discussed are performed in one embodiment by an appropriate processor (or processors) of a processing (i.e., computer) system executing instructions (computer-readable code) stored in storage. It will also be understood that the invention is not limited to any particular implementation or programming technique and that the invention may be implemented using any appropriate techniques for implementing the functionality described herein. The invention is not limited to any particular programming language or operating system.

It should be appreciated that in the above description of exemplary embodiments of the invention, various features of the invention are sometimes grouped together in a single embodiment, FIG., or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Furthermore, some of the embodiments are described herein as a method or combination of elements of a method that can be implemented by a processor of a computer system or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the invention.

In the description provided herein, numerous specific details are set forth. However, it is understood that embodiments of the invention may be practiced without these specific details. In other instances, well-known methods, structures and techniques have not been shown in detail in order not to obscure an understanding of this description.

Similarly, it is to be noticed that the term coupled, when used in the claims, should not be interpreted as being limited to direct connections only. The terms “coupled” and “connected,” along with their derivatives, may be used. It should be understood that these terms are not intended as synonyms for each other. Thus, the scope of the expression a device A coupled to a device B should not be limited to devices or systems wherein an output of device A is directly connected to an input of device B. It means that there exists a path between an output of A and an input of B which may be a path including other devices or means. “Coupled” may mean that two or more elements are either in direct physical or electrical contact, or that two or more elements are not in direct contact with each other but yet still co-operate or interact with each other.

Thus, while there has been described what are believed to be the preferred embodiments of the invention, those skilled in the art will recognize that other and further modifications may be made thereto without departing from the spirit of the invention, and it is intended to claim all such changes and modifications as falling within the scope of the invention. For example, any formulas given above are merely representative of procedures that may be used. Functionality may be added or deleted from the block diagrams and operations may be interchanged among functional blocks. Steps may be added or deleted to methods described within the scope of the present invention.

1. A method for operating a computer system thereby to manage a lost property facility, the method including:
maintaining access to a database that is configured to store a plurality of user records, wherein each user record contains: (i) data representative of a RFID token UID for a unique RFID token, wherein the RFID token UID is unique relative to a first collection of identifiers; and (ii) data representative of a user contact;
receiving data representative of a visually readable identifier, and a specific user contact, wherein the visually readable identifier is unique relative to a second collection of identifiers, wherein the number of possible unique identifiers in the second collection is less than the number of possible unique identifiers in the first collection, and wherein the visually readable identifier is not directly representative of the RFID token UID;
accessing an information repository which associates each RFID token UID to one of the visually readable identifiers, and thereby identifying RFID token UID associated with the visually readable identifier based on accessing an information repository that associates each RFID token UID with a unique visually readable identifier;
causing updating of the database to store a record containing: (i) data representative of the identified RFID token UID; (ii) data representative of the specific visually readable identifier; and (iii) data representative of the specific user contact;
receiving a signal from a lost property device, wherein the lost property device includes a reader device that is configured to read a RFID token carried by an item that is placed in a location associated with the lost property device, wherein the signal is representative of a read RFID token UID;
querying the database thereby to identify a record containing the read RFID token UID, and determine the user contact for that record; and
causing transmittal of an electronic notification to the determined user contact.

2. A method according to claim 1 wherein: the data representative of a specific visually readable identifier and a specific user contact is received by way of an electronic communication sent via the specific user contact; and wherein the received data is representative of the user contact as a result of originating from that contact.

3. A method according to claim 2 wherein the message includes one or more of: (i) a SMS; (ii) and email; and (iii) another form of electronic communication.

4. A method for managing a lost property facility, the method including:
providing a plurality of garments, wherein each garment carries: (i) a RFID token having a token UID, wherein the RFID token UID is unique relative to a first collection of identifiers; and (ii) a visually readable identifier, wherein the visually readable identifier is unique relative to a second collection of identifiers, wherein the number of possible unique identifiers in the second collection is less than the number of possible unique identifiers in the first collection, and wherein the visually readable identifier is not directly representative of the RFID token UID wherein an information repository associates, for each garment, the RFID token with the visually readable identifier;
providing a plurality of lost property devices, wherein each lost property device includes a reader device that is configured to: (i) read a RFID token carried by an item that is placed in a storage location associated with the lost property device, thereby to determine the token UID; and (ii) in response to reading a given RFID token, communicate a signal to a server device, wherein the signal is representative of a read RFID token UID;
providing a portal that is configured to receive electronic messages from user devices, wherein each electronic message is: (i) received from a specific user contact; and (ii) includes data representative of the visually readable identifier for a given garment;
performing an automated process, in response to a given electronic message received via the portal, thereby to cause a database to store a record that contains: (i) data representative of the RFID token associated with the visually readable identifier of which the electronic message is representative; and (ii) the contact from which the electronic message is received; and
configuring the server device to process a signal received from a given one of the lost property device, wherein the processing includes: (i) querying the database; (ii) identifying the contact for a record that contains the RFID token UID of which the signal is representative; and (iii) communicating an electronic message to the contact.

5. (canceled)

6. (canceled)

7. A method according to claim 1 wherein the lost property device is configured such that the reader device is configured to read a RFID token carried by an item that is placed in a receptacle but not a RFID token carried by an item that passes proximal the receptacle.

8. A method according to claim 7 wherein the lost property device includes shielding configured to prevent reading of a RFID token carried by an item that passes proximal the receptacle.

9. A method according to claim 1 wherein the lost property device is configured such that the reader device performs a scanning procedure to read proximal tokens on a predefined schedule.

10. A method for operating a computer system thereby to manage a lost property facility, the method including:
maintaining access to a database that is configured to store a plurality of user records, wherein each user record contains: (i) data representative of a RFID token UID for a unique RFID token, wherein the RFID token UID is unique relative to a first collection of identifiers; and (ii) data representative of a user contact;
receiving, in respect of a sales transaction for an item carrying one of the unique RFID tokens, data representative of the unique RFID token, and data representative of an associated visually readable identifier wherein the visually readable identifier is unique relative to a second collection of identifiers, wherein the number of possible unique identifiers in the second collection is less than the number of possible unique identifiers in the first collection, and wherein the visually readable identifier is not directly representative of the RFID token UID, and a specific user contact, wherein the data is provided by a computer system configured to perform a sales transaction in respect the item and receive input representative of the specific user contact in the context of that transaction;
causing updating of the database to store a record containing: (i) data representative of the identified RFID token UID; and (ii) data representative of the specific user contact;
receiving a signal from a lost property device, wherein the lost property device includes a reader device that is configured to read a RFID token carried by an item that is placed in a location associated with the lost property device, wherein the signal is representative of a read RFID token UID;
querying the database thereby to identify a record containing the read RFID token UID, and determine the user contact for that record; and
causing transmittal of an electronic notification to the determined user contact.

11. A method according to claim 10 wherein the sales transaction is performed by an Internet-based store, such that causing updating of the database to store a record containing: (i) data representative of the identified RFID token UID; and (ii) data representative of the specific user contact occurs automatically in response to a purchase transaction via the Internet-based store.

12. A method according to claim 10 wherein the sales transaction is performed at a POS terminal, such that causing updating of the database to store a record containing: (i) data representative of the identified RFID token UID; and (ii) data representative of the specific user contact occurs automatically in response to a purchase transaction via the POS terminal.

13. A method according to claim 10 wherein the data representative of a specific user contact is input as part of the sales transaction.

14. A method according to claim 10 wherein the data representative of a specific user contact is extracted from a pre-existing user account associated with a user making a purchase via the sales transaction.

15. A method according to claim 1 wherein the item is a wearable garment in which the token is embedded.

16. (canceled)

17. A computer system configured to perform a method according to claim 1.

18. A computer program configured to perform a method according to claim 1.

19. A non-transitory carrier medium carrying computer executable code that, when executed on a processor, causes the processor to perform a method according to claim 1.

20. A computer system configured to perform a method according to claim 10.

21. A computer program configured to perform a method according to claim 10.

22. A non-transitory carrier medium carrying computer executable code that, when executed on a processor, causes the processor to perform a method according to claim 10.
